(19) United States
(12) Patent Application Publication
(10) Pub. No.: US 2024/0221346 A1
(43) Pub. Date: Jul. 4, 2024

(54) MODEL TRAINING METHOD AND APPARATUS, PEDESTRIAN RE-IDENTIFICATION METHOD AND APPARATUS, AND ELECTRONIC DEVICE

(71) Applicant: BEIJING BAIDU NETCOM SCIENCE TECHNOLOGY CO., LTD., Beijing (CN)

(72) Inventors: Zhigang WANG, Beijing (CN); Jian WANG, Beijing (CN); Hao SUN, Beijing (CN); Errui DING, Beijing (CN)

(21) Appl. No.: 17/800,880

(22) PCT Filed: Jan. 29, 2022
(86) PCT No.: PCT/CN2022/075112

§ 371 Date: Oct. 13, 2022

(30) Foreign Application Priority Data
Apr. 7, 2021 (CN) 202110372249.5

(51) Int. Cl. G06V 10/44; G06T 9/00; G06V 10/74; G06V 10/762; G06V 10/80

(52) U.S. Cl. CPC G06V 10/44; G06T 9/00; G06V 10/761; G06V 10/762; G06V 10/806

(57) ABSTRACT

The present disclosure provides a model training method and apparatus, a pedestrian re-identification method and apparatus, and an electronic device, and relates to the field of artificial intelligence, and specifically to computer vision and deep learning technologies, which can be applied to smart city scenarios. A specific implementation solution is: performing, by using a first encoder, feature extraction on a first pedestrian image and a second pedestrian image in a sample dataset, to obtain an image feature of the first pedestrian image and an image feature of the second pedestrian image; fusing the image feature of the first pedestrian image and the image feature of the second pedestrian image, to obtain a fused feature; performing, by using a first decoder, feature decoding on the fused feature, to obtain a third pedestrian image; and determining the third pedestrian image as a negative sample image of the first pedestrian image, and using the first pedestrian image and the negative sample image to train a first preset model to convergence, to obtain a pedestrian re-identification model. The embodiments of the present disclosure can improve the effect of the model in distinguishing between pedestrians with similar appearances but different identities.

This application claims priority to Chinese Patent Application No. 202110372249.5, filed on Apr. 7, 2021, and entitled “MODEL TRAINING METHOD AND APPARATUS, PEDESTRIAN RE-IDENTIFICATION METHOD AND APPARATUS, AND ELECTRONIC DEVICE”, which is incorporated by reference in its entirety.

### TECHNICAL FIELD

The present disclosure relates to the field of artificial intelligence, and specifically to computer vision and deep learning technologies, which can be applied to smart city scenarios.

### BACKGROUND

Pedestrian re-identification, also known as Re-ID, is a technology that uses computer vision technology to determine whether a specific pedestrian is present in an image or a video sequence. Typically, a large number of sample images may be used to perform supervised training or unsupervised training on a pedestrian re-identification model, and a model that has been trained to convergence is used to complete a pedestrian re-identification task. The performance of the converged model depends on the quality and difficulty of the sample images. In general, the model can distinguish between pedestrians with significantly different appearances, while it has difficulties in distinguishing between those with similar appearances but different identities.

### SUMMARY

The present disclosure provides a model training method and apparatus, a pedestrian re-identification method and apparatus, and an electronic device.

According to an aspect of the present disclosure, there is provided a model training method, including:
performing, by using a first encoder, feature extraction on a first pedestrian image and a second pedestrian image in a sample dataset, to obtain an image feature of the first pedestrian image and an image feature of the second pedestrian image;
fusing the image feature of the first pedestrian image and the image feature of the second pedestrian image, to obtain a fused feature;
performing, by using a first decoder, feature decoding on the fused feature, to obtain a third pedestrian image; and
determining the third pedestrian image as a negative sample image of the first pedestrian image, and using the first pedestrian image and the negative sample image to train a first preset model to convergence, to obtain a pedestrian re-identification model.

According to another aspect of the present disclosure, there is provided a pedestrian re-identification method, including:
separately performing, by using a pedestrian re-identification model, feature extraction on a target image and a candidate pedestrian image, to obtain a pedestrian feature of the target image and a pedestrian feature of the candidate pedestrian image, where the pedestrian re-identification model is obtained using the model training method according to any one of the embodiments of the present disclosure;
determining a similarity between the target image and the candidate pedestrian image based on the pedestrian feature of the target image and the pedestrian feature of the candidate pedestrian image; and
determining the candidate pedestrian image as a related image of the target image when the similarity meets a preset condition.

According to another aspect of the present disclosure, there is provided a model training apparatus, including:
a first encoding module configured to perform, by using a first encoder, feature extraction on a first pedestrian image and a second pedestrian image in a sample dataset, to obtain an image feature of the first pedestrian image and an image feature of the second pedestrian image;
a fusion module configured to fuse the image feature of the first pedestrian image and the image feature of the second pedestrian image, to obtain a fused feature;
a first decoding module configured to perform, by using a first decoder, feature decoding on the fused feature, to obtain a third pedestrian image; and
a first training module configured to determine the third pedestrian image as a negative sample image of the first pedestrian image, and use the first pedestrian image and the negative sample image to train a first preset model to convergence, to obtain a pedestrian re-identification model.

According to another aspect of the present disclosure, there is provided a pedestrian re-identification apparatus, including:
a second extraction module configured to separately perform, by using a pedestrian re-identification model, feature extraction on a target image and a candidate pedestrian image, to obtain a pedestrian feature of the target image and a pedestrian feature of the candidate pedestrian image, where the pedestrian re-identification model is obtained using the model training method according to any one of the embodiments of the present disclosure;
a third similarity module configured to determine a similarity between the target image and the candidate pedestrian image based on the pedestrian feature of the target image and the pedestrian feature of the candidate pedestrian image; and
a second determining module configured to determine the candidate pedestrian image as a related image of the target image when the similarity meets a preset condition.

According to another aspect of the present disclosure, there is provided an electronic device, including:
at least one processor; and
a memory communicatively connected to the at least one processor, where
the memory stores instructions executable by the at least one processor, and when executed by the at least one processor, the instructions cause the at least one processor to perform the method according to any one of the embodiments of the present disclosure.

According to another aspect of the present disclosure, there is provided a non-transitory computer-readable storage medium storing computer instructions, where the computer instructions are used to cause a computer to perform the method according to any one of the embodiments of the present disclosure.

According to another aspect of the present disclosure, there is provided a computer program product, including a computer program, where when the computer program is executed by a processor, the method according to any one of the embodiments of the present disclosure is implemented.

According to the technology of the present disclosure, the third pedestrian image is obtained by fusing the image feature of the first sample image and the image feature of the second sample image, and therefore, the third pedestrian image includes information in the first pedestrian image, and also has a difference from the first pedestrian image. The difficulty in distinguishing between the first pedestrian image and its negative sample can be enhanced by using the third pedestrian image as the negative sample of the first pedestrian image. The pedestrian re-identification model is obtained through training based on the samples that are difficult to distinguish, thereby improving the effect of the model in distinguishing between pedestrians with similar appearances but different identities.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the solutions, and do not constitute a limitation on the present disclosure. In the accompanying drawings:

FIG. 1 is a schematic diagram of a model training method according to an embodiment of the present disclosure;

FIG. 2 is a schematic diagram of a first phase in a model training method according to another embodiment of the present disclosure;

FIG. 3 is a schematic diagram of a second phase in a model training method according to another embodiment of the present disclosure;

FIG. 4 is a schematic diagram of a third phase in a model training method according to another embodiment of the present disclosure;

FIG. 5 is a schematic diagram of a pedestrian re-identification method according to an embodiment of the present disclosure;

FIG. 6 is a schematic diagram of a model training apparatus according to an embodiment of the present disclosure;

FIG. 7 is a schematic diagram of a model training apparatus according to another embodiment of the present disclosure;

FIG. 8 is a schematic diagram of a model training apparatus according to still another embodiment of the present disclosure;

FIG. 9 is a schematic diagram of a pedestrian re-identification apparatus according to an embodiment of the present disclosure; and

FIG. 10 is a block diagram of an electronic device for implementing a method according to an embodiment of the present disclosure.

### DETAILED DESCRIPTION OF EMBODIMENTS

Exemplary embodiments of the present disclosure are described below in conjunction with the accompanying drawings, where various details of the embodiments of the present disclosure are included to facilitate understanding, and should only be considered as exemplary. Therefore, those of ordinary skill in the art should be aware that various changes and modifications can be made to the embodiments described herein, without departing from the scope and spirit of the present disclosure. Likewise, for clarity and conciseness, the description of well-known functions and structures is omitted in the following description.

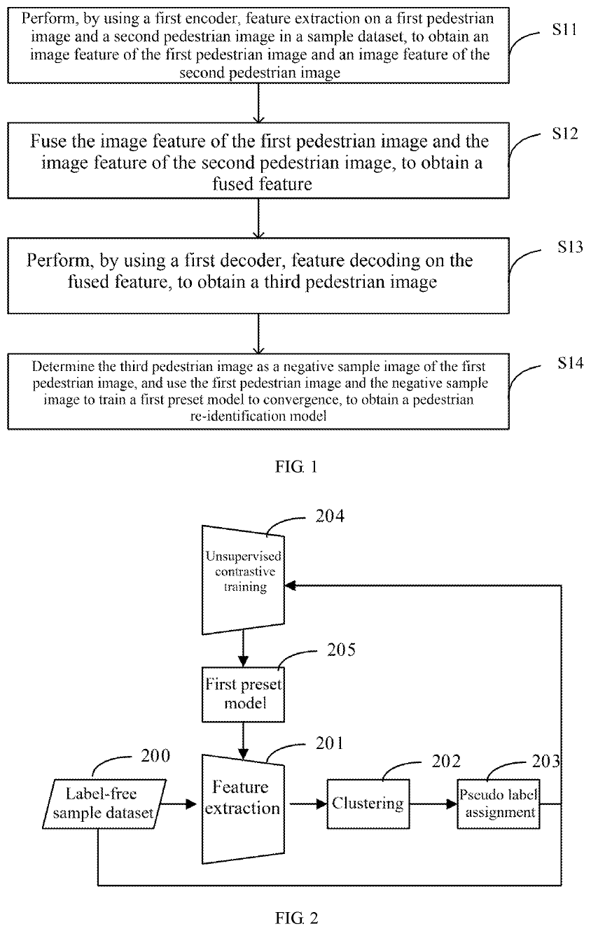

FIG. 1 is a schematic diagram of a model training method according to an embodiment of the present disclosure. As shown in FIG. 1, the model training method includes:
step S11: performing, by using a first encoder, feature extraction on a first pedestrian image and a second pedestrian image in a sample dataset, to obtain an image feature of the first pedestrian image and an image feature of the second pedestrian image;
step S12: fusing the image feature of the first pedestrian image and the image feature of the second pedestrian image, to obtain a fused feature;
step S13: performing, by using a first decoder, feature decoding on the fused feature, to obtain a third pedestrian image;
step S14: determining the third pedestrian image as a negative sample image of the first pedestrian image, and using the first pedestrian image and the negative sample image to train a first preset model to convergence, to obtain a pedestrian re-identification model.

The first encoder in step S11 may be configured to extract an image feature based on a pedestrian image, and the first decoder in step S13 may be configured to obtain a new image by decoding the image feature. Therefore, the first encoder and the first decoder may form an image generation model to reconstruct a new pedestrian image based on an input pedestrian image. The image feature extracted by the first encoder may be represented by a first vector, which may include multi-dimensional feature information of the corresponding pedestrian image.

In this embodiment of the present disclosure, different pedestrian images in the sample dataset, such as the first pedestrian image and the second pedestrian image, may be input to the first encoder, and the first encoder outputs the corresponding image features. The image features are fused, to obtain the fused feature. The fused feature is then input to the first decoder, and the first decoder reconstructs and outputs the third pedestrian image based on the fused feature.

The third pedestrian image is reconstructed based on the fused feature of the first pedestrian image and the second pedestrian image, and therefore includes both information of the first pedestrian image and information of the second pedestrian image. The third pedestrian image is used as the negative sample image of the first pedestrian image, which makes it more difficult to distinguish between the first pedestrian image and its negative sample image. The pedestrian re-identification model is obtained through training based on the samples that are difficult to distinguish, thereby improving the effect of the model in distinguishing between pedestrians with similar appearances but different identities.

Exemplarily, the sample dataset may include at least two pedestrian images. Each pedestrian image corresponds to one pedestrian. Different pedestrian images may correspond to different pedestrians, or correspond to the same pedestrian.

In practical applications, an image may be sampled from the sample dataset as the first sample image. With the first sample image as a reference, an image that differs significantly from the first pedestrian image, such as an image corresponding to a different pedestrian from the first pedestrian image, is used as the second sample image. The third pedestrian image is reconstructed based on the sampled images. The first pedestrian image and the third pedestrian image are input to the first preset model. After separately processing the first pedestrian image and the third pedestrian image, the first preset model outputs corresponding processing results, such as pedestrian features or pedestrian identifiers in the images. According to the processing results from the first preset model and a loss function corresponding to the first preset model, a function value of the loss function is computed. In addition, the first preset model is updated based on the function value of the loss function, until the first preset model meets a convergence condition, for example, a number of updates reaches a first preset threshold, the function value of the loss function is less than a second preset threshold, or the function value of the loss function no longer changes, and then the converged first preset model is determined as the pedestrian re-identification model that can be used to complete a pedestrian re-identification task.

Exemplarily, the loss function corresponding to the first preset model may be used to constrain the first preset model to push the processing result of the first pedestrian image away from the processing result of the negative sample image, or in other words, to cause the first preset model to output, for the first pedestrian image and the negative sample image, processing results that are as distant from each other as possible in a feature space. As such, the first preset model can distinguish between different pedestrian images.

Exemplarily, one third pedestrian image may be generated in each sampling process, to form one positive and negative sample pair including the first pedestrian image and the third pedestrian image, and then the positive and negative sample pair is used to perform the related operation of updating the first preset model; and then a next sampling process is performed. Alternatively, a corresponding negative sample image may be obtained for each pedestrian image in the sample dataset, to form a plurality of positive and negative sample pairs, and then the plurality of positive and negative sample pairs are used to perform the related operation of updating the first preset model multiple times.

Exemplarily, during the process in which the first preset model is updated to implement the training of the first preset model, the first encoder and the first decoder may also be updated. Specifically, the model training method may further include:
determining a first similarity based on the first pedestrian image and the negative sample image;
determining, based on at least one pedestrian image other than the first pedestrian image in the sample image set, at least one second similarity respectively corresponding to the at least one pedestrian image; and
updating the first encoder and the first decoder based on the first similarity, the at least one second similarity, and an adversarial loss function.

The adversarial loss function may be used to constrain the first similarity to be greater than any one of the at least one second similarity. The first encoder and the first decoder are updated based on the first similarity, the at least one second similarity, and the adversarial loss function, so that the image reconstructed by the first encoder and the first decoder can be more similar to the first pedestrian image, which increases the difficulty in distinguishing between the first pedestrian image and the negative sample image, thereby further improving the effect of the pedestrian re-identification model.

Exemplarily, a function value of the adversarial loss function may be computed based on the first similarity and the second similarity, and the first encoder and the first decoder are updated based on the function value of the adversarial loss function.

In some scenarios, the first encoder and the first decoder may be further updated based on a reconstruction loss function and/or the authenticity of the negative sample image. The reconstruction loss function may be used to constrain a similarity between the image reconstructed by the first encoder and the first decoder and the first pedestrian image and/or the second pedestrian image to be greater than a preset threshold. In other words, the reconstructed image has a similarity to the input images. The authenticity may be determined by using an authenticity discriminator. As an example, the function value of the adversarial loss function and a function value of the reconstruction loss function may be computed, the authenticity is determined, and then the first encoder and the second encoder are updated based on the three.

During the process in which the first pedestrian image and its negative sample image are used to train the first preset model in order to obtain the pedestrian re-identification model, the first pedestrian image and the negative sample image are also used to train the first encoder and the second decoder. Therefore, the first encoder and the first decoder also gradually improve the quality of the reconstructed negative sample image, thereby gradually improving the training effect of the first preset model.

Exemplarily, the first encoder and the first decoder may be obtained through pre-training based on pedestrian images. Specifically, a manner of obtaining the first encoder and the first decoder includes:
performing, by using a second encoder, feature extraction on an i^{th} pedestrian image in the sample dataset, to obtain an image feature of the i^{th} pedestrian image, where i is a positive integer that is greater than or equal to 1;
performing, by using a second decoder, feature decoding on the image feature of the i^{th} pedestrian image, to obtain a generated image;
updating the second encoder and the second decoder based on a similarity between the i^{th} pedestrian image and the generated image, and a reconstruction loss function; and
determining the second encoder as the first encoder, and the second decoder as the first decoder when the second encoder and the second decoder meet a convergence condition.

The reconstruction loss function is used to constrain the similarity between the i^{th} pedestrian image and the generated image to be less than a preset threshold. In other words, the reconstruction loss function constrains the image obtained by decoding is similar to the image input for encoding.

Based on the above process, the second encoder and the second decoder gradually improve the ability to reconstruct images similar to input images. The second encoder and the second decoder are determined as the first encoder and the first decoder when the convergence condition is met, so that the first encoder and the first decoder have the ability of reconstructing similar images. Therefore, applying the first encoder and the first decoder to generate the negative sample image can improve the generation effect, thereby improving the training effect of the pedestrian re-identification model.

Exemplarily, the updating the second encoder and the second decoder based on a similarity between the i^{th} pedestrian image and the generated image, and a reconstruction loss function includes:
computing a function value of the reconstruction loss function based on the similarity between the i^{th} pedestrian image and the generated image, and the reconstruction loss function;
determining, by using an authenticity discriminator, the authenticity of the generated image; and
updating the second encoder and the second decoder according to the function value of the reconstruction loss function and the authenticity of the generated image.

In other words, during the training process, the reconstruction loss function is used not only to constrain the image generated by the second encoder and the second decoder to be similar to the input image, but also to constrain the generated image to be as realistic as possible. Applying the first encoder and the first decoder that are obtained by training the second encoder and the second decoder to generate the negative sample image can improve the generation effect, thereby improving the training effect of the pedestrian re-identification model.

Exemplarily, the first preset model may also be obtained through pre-training. Specifically, a manner of obtaining the first preset model includes:
performing, by using a second preset model, feature extraction on each pedestrian image in the sample dataset, to obtain a pedestrian feature of each pedestrian image;
performing, based on the pedestrian feature, clustering on each pedestrian image in the sample dataset, to obtain at least two class clusters respectively corresponding to at least two class cluster labels, where each of the at least two class clusters includes at least one pedestrian image; and
training, based on each pedestrian image in the sample dataset and a class cluster label corresponding to each pedestrian image, the second preset model to convergence, to obtain the first preset model.

The pedestrian feature may be represented by a second vector. The second vector includes multi-dimensional features of a pedestrian corresponding to the pedestrian image.

It should be noted that each encoder and the first preset model, the second preset model, and the pedestrian re-identification model in the embodiments of the present disclosure may all be used to perform the feature extraction. Each encoder or model may extract features of different dimensions in the same manner or different manners. For example, the encoder may mainly extract a feature related to an image effect such as color; and the first preset model, the second preset model, and the pedestrian re-identification model may mainly extract a feature related to a pedestrian such as a pedestrian's height.

Exemplarily, the clustering of the pedestrian image may be implemented based on at least one of density-based spatial clustering of applications with noise (DBSCAN), k-means clustering algorithm (k-means), etc.

Through clustering, the pedestrian images are classified into different class clusters. A class cluster label of each class cluster may be served as a pseudo label of each pedestrian image in the class cluster. Each pedestrian image and its class cluster label or its pseudo label is used to train the second preset model, which can implement unsupervised training, thereby reducing the cost of annotating each pedestrian image.

In practical applications, during the process in which the second preset model is trained to convergence in order to obtain the first preset model, a loss function corresponding to the second preset model may be used to constrain the second preset model to push processing results of pedestrian images in different class clusters away from each other, and to pull processing results of pedestrian images in the same class cluster close to each other. This enables the second preset model to gradually improve the ability to distinguish between different pedestrian images.

Exemplarily, the first pedestrian image and the second pedestrian image may be from different class clusters in the at least two class clusters.

The images in different class clusters are used as the first pedestrian image and second pedestrian image, which can ensure that the third pedestrian image reconstructed by using the fused feature is different from the first pedestrian image, thereby ensuring that the pedestrian re-identification model obtains the ability to accurately distinguish.

The following presents a specific application example for the purpose of describing an optional implementation of the model training method according to the embodiments of the present disclosure. In the application example, the model training method is used to obtain the pedestrian re-identification model through training. Specifically, there are three phases.

FIG. 2 is a schematic diagram of a first phase. As shown in FIG. 2, the first phase includes the following steps.

Feature extraction step 201: performing, by using an initialized model, feature extraction on each pedestrian image in a label-free sample dataset 200. The initialized model is denoted as a second preset model, and may be obtained through training by using a plurality of labeled pedestrian images.

Clustering step 202: performing clustering on features extracted in step 201 by using one or more of the clustering algorithms such as DBSCAN and k-means, to implement clustering of the images in the label-free sample dataset 200. In this way, the images in the label-free sample dataset 200 are classified into different class clusters in a feature space.

Pseudo label assignment step 203: assigning a pseudo label to each image, according to a corresponding class cluster of each image in the feature space. The pseudo label is a corresponding class cluster index.

Unsupervised contrastive training step 204: training the second preset model according to the pseudo label assigned to each image in step 203 and a loss function. The loss function constrains the images in the same class cluster to be close to each other in the feature space, and the images in different class clusters to be away from each other in the feature space.

Through the iterative training process in step 204, the second preset model converges, to obtain a first preset model 205.

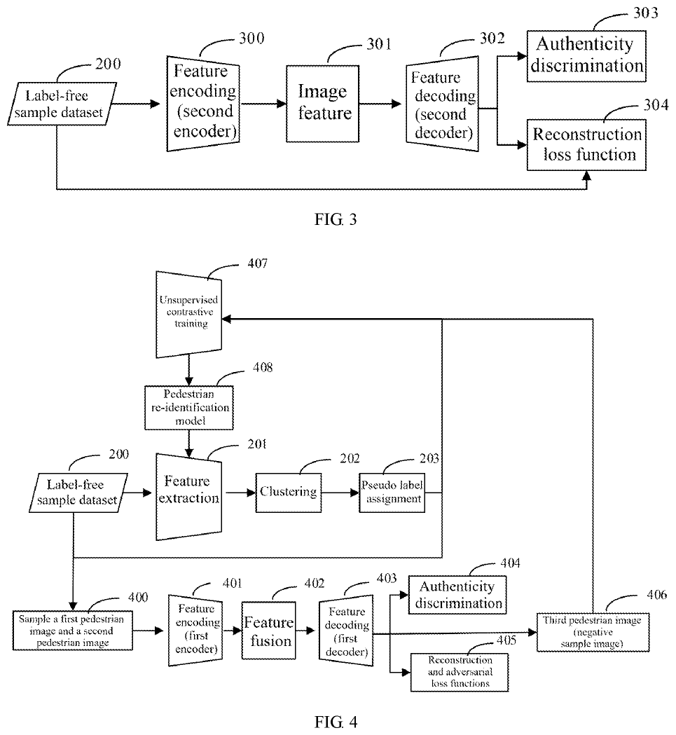

FIG. 3 is a schematic diagram of a second phase. The second phase is used to train an image generation model, which includes an encoder and a decoder. The second phase is to enable the image generation model to have the ability to reconstruct natural images from abstract features. The second phase includes the following steps.

Feature encoding step 300: performing, by using a second encoder in the image generation model, feature extraction on each image in the label-free sample dataset 200, to obtain a corresponding image feature 301.

Feature decoding step 302: decoding, by using a second decoder in the image generation model, the image feature 301, to obtain a generated image.

Authenticity discrimination step 303: determining, by using an authenticity discriminator, the authenticity of the generated image. This step is used to constrain the generated image output by the image generation model to be as realistic as possible.

Reconstruction loss function computing step 304: computing a reconstruction loss function according to the generated image and the image that is in the label-free sample dataset 200 and that is input to the image generation model, where the reconstruction loss function is used to constrain the generated image obtained through decoding by the second decoder to be similar to the image input to the second encoder.

The image generation model may be updated based on the outputs of step 303 and step 304. When a preset convergence condition is met, the second encoder in the image generation model may be determined as a first encoder, and the second decoder in the image generation model may be determined as a first decoder, so that the first encoder and the first decoder are applied in a third phase.

FIG. 4 is a schematic diagram of a third phase. As shown in FIG. 4, the third phase includes the following steps.

Sampling step 400: sequentially sampling each image in the label-free sample dataset 200 as a reference image, namely a first pedestrian image; and sampling an image that does not belong to the same class cluster as the first pedestrian image as a second pedestrian image.

Feature encoding step 401: separately performing, by using the first encoder in the image generation model, feature extraction on the first pedestrian image and the second pedestrian image, to obtain corresponding image features.

Feature fusion step 402: performing weighted fusion on the images obtained in step 401, to obtain a fused feature.

Feature decoding step 403: decoding the fused feature by using the first decoder in the image generation model, to obtain a third pedestrian image 406.

Authenticity discrimination step 404: determining, by using the authenticity discriminator, the authenticity of the third pedestrian image 406.

Reconstruction and adversarial loss functions 405: computing an adversarial loss function in addition to computing a reconstruction loss function in this step. The adversarial loss function constrains a similarity between the third pedestrian image 406 and the first pedestrian image to be greater than similarities between the third pedestrian image 406 and the other images in the label-free sample dataset 200. In other words, the generated third pedestrian image has a similarity in appearance to the first pedestrian image.

Unsupervised training step 407: using the third pedestrian image as a negative sample of the first pedestrian image, and performing unsupervised training on the first preset model in this step. In addition to the constraint from the loss function in the unsupervised training step in the first phase, the loss function in this step further constrains to push the first pedestrian image and the negative sample image away from each other as much as possible in the feature space, such that the model has the effect of distinguishing between samples that are difficult to distinguish. Finally, a pedestrian re-identification model 408 is output.

According to the method of this embodiment of the present disclosure, the third pedestrian image is obtained by fusing the image feature of the first sample image and the image feature of the second sample image, and therefore, the third pedestrian image includes information in the first pedestrian image, and also has a difference from the first pedestrian image. The difficulty in distinguishing between the first pedestrian image and its negative sample can be enhanced by using the third pedestrian image as the negative sample of the first pedestrian image. The pedestrian re-identification model is obtained through training based on the samples that are difficult to distinguish, thereby improving the effect of the model in distinguishing between pedestrians with similar appearances but different identities.

An embodiment of the present disclosure further provides an application method of the foregoing pedestrian re-identification model. FIG. 5 shows a pedestrian re-identification method according to an embodiment of the present disclosure, the method including the following steps:
step S51: separately performing, by using a pedestrian re-identification model, feature extraction on a target image and a candidate pedestrian image, to obtain a pedestrian feature of the target image and a pedestrian feature of the candidate pedestrian image, where the pedestrian re-identification model is obtained using the model training method according to any one of the embodiments of the present disclosure;
step S52: determining a similarity between the target image and the candidate pedestrian image based on the pedestrian feature of the target image and the pedestrian feature of the candidate pedestrian image; and
step S53: determining the candidate pedestrian image as a related image of the target image when the similarity meets a preset condition.

The preset condition is, for example, that the similarity is less than a preset threshold or that the similarity is the smallest, etc.

According to the model training method provided in the embodiments of the present disclosure, the pedestrian re-identification model is obtained through training based on the samples that are difficult to distinguish. Therefore, the pedestrian re-identification model can be used to accurately extract the pedestrian feature of each image, and compute the similarity based on the pedestrian feature of each image, and accurately determine the related image of the target image from the candidate pedestrian images based on the computed similarity.

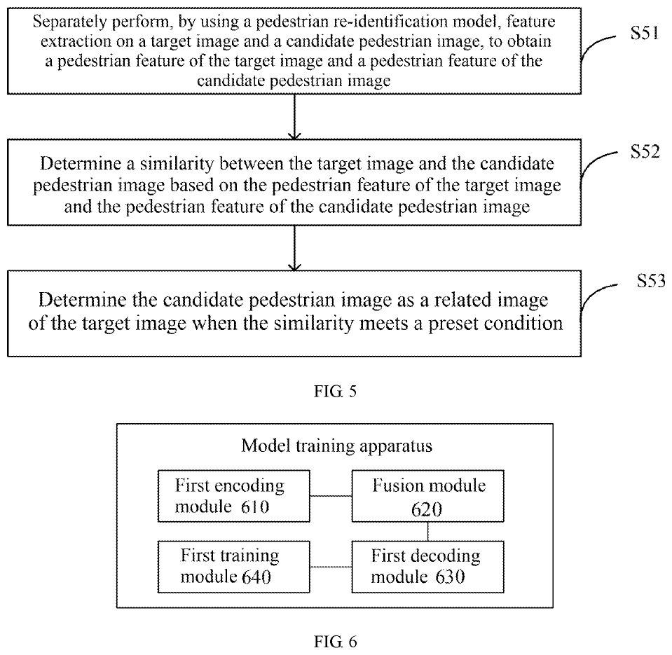

As an implementation of any one of the foregoing methods, the present disclosure further provides a model training apparatus. As shown in FIG. 6, the apparatus includes:
a first encoding module 610 configured to perform, by using a first encoder, feature extraction on a first pedestrian image and a second pedestrian image in a sample dataset, to obtain an image feature of the first pedestrian image and an image feature of the second pedestrian image;
a fusion module 620 configured to fuse the image feature of the first pedestrian image and the image feature of the second pedestrian image, to obtain a fused feature;
a first decoding module 630 configured to perform, by using a first decoder, feature decoding on the fused feature, to obtain a third pedestrian image; and
a first training module 640 configured to determine the third pedestrian image as a negative sample image of the first pedestrian image, and use the first pedestrian image and the negative sample image to train a first preset model to convergence, to obtain a pedestrian re-identification model.

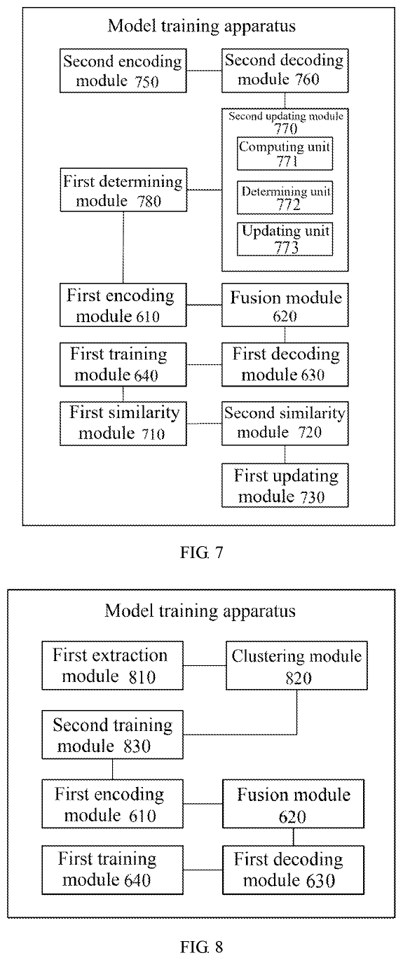

Exemplarily, as shown in FIG. 7, the apparatus further includes:
a first similarity module 710 configured to determine a first similarity based on the first pedestrian image and the negative sample image;
a second similarity module 720 configured to determine, based on at least one pedestrian image other than the first pedestrian image in the sample image set, at least one second similarity respectively corresponding to the at least one pedestrian image; and
a first updating module 730 configured to update the first encoder and the first decoder based on the first similarity, the at least one second similarity, and an adversarial loss function. Exemplarily, as shown in FIG. 7, the apparatus further includes:
a second encoding module 750 configured to perform, by using a second encoder, feature extraction on an i^{th} pedestrian image in the sample dataset, to obtain an image feature of the i^{th} pedestrian image, where i is a positive integer that is greater than or equal to 1;
a second decoding module 760 configured to perform, by using a second decoder, feature decoding on the image feature of the i^{th} pedestrian image, to obtain a generated image;
a second updating module 770 configured to update the second encoder and the second decoder based on a similarity between the i^{th} pedestrian image and the generated image, and a reconstruction loss function; and
a first determining module 780 configured to determine the second encoder as the first encoder, and the second decoder as the first decoder when the second encoder and the second decoder meet a convergence condition.

Exemplarily, the second updating module 770 includes:
a computing unit 771 configured to compute a function value of the reconstruction loss function based on the similarity between the i^{th} pedestrian image and the generated image, and the reconstruction loss function;
a determining unit 772 configured to determine, by using an authenticity discriminator, the authenticity of the generated image; and
an updating unit 773 configured to update the second encoder and the second decoder according to the function value of the reconstruction loss function and the authenticity of the generated image.

Exemplarily, as shown in FIG. 8, the apparatus further includes:
a first extraction module 810 configured to perform, by using a second preset model, feature extraction on each pedestrian image in the sample dataset, to obtain a pedestrian feature of each pedestrian image;
a clustering module 820 configured to perform, based on the pedestrian feature, clustering on each pedestrian image in the sample dataset, to obtain at least two class clusters respectively corresponding to at least two class cluster labels, where each of the at least two class clusters includes at least one pedestrian image; and
a second training module 830 configured to train, based on each pedestrian image in the sample dataset and a class cluster label corresponding to each pedestrian image, the second preset model to convergence, to obtain the first preset model.

Exemplarily, the first pedestrian image and the second pedestrian image are from different class clusters in the at least two class clusters.

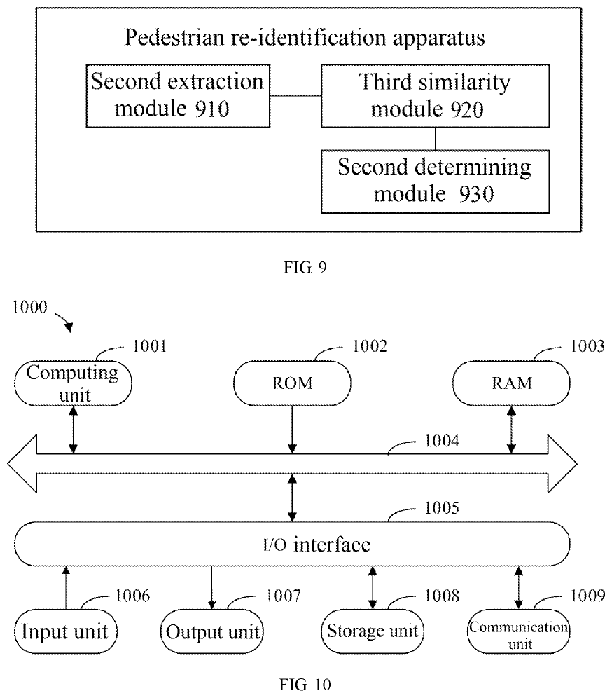

An embodiment of the present disclosure further provides a pedestrian re-identification apparatus, as shown in FIG. 9, the apparatus including:
a second extraction module 910 configured to separately perform, by using a pedestrian re-identification model, feature extraction on a target image and a candidate pedestrian image, to obtain a pedestrian feature of the target image and a pedestrian feature of the candidate pedestrian image, where the pedestrian re-identification model is obtained according to the foregoing model training method;
a third similarity module 920 configured to determine a similarity between the target image and the candidate pedestrian image based on the pedestrian feature of the target image and the pedestrian feature of the candidate pedestrian image; and
a second determining module 930 configured to determine the candidate pedestrian image as a related image of the target image when the similarity meets a preset condition.

For the functions of the units, modules, or submodules in each apparatus of the embodiments of the present disclosure, reference may be made to the corresponding description in the foregoing method embodiments, and details are not described herein again.

According to an embodiment of the present disclosure, the present disclosure further provides an electronic device, a readable storage medium, and a computer program product.

FIG. 10 is a schematic block diagram of an example electronic device 1000 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 10, the electronic device 1000 includes a computing unit 1001, which may perform various appropriate actions and processing according to a computer program stored in a read-only memory (ROM) 1002 or a computer program loaded from a storage unit 1008 to a random access memory (RAM) 1003. The RAM 1003 may further store various programs and data required for the operation of the electronic device 1000. The computing unit 1001, the ROM 1002, and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard or a mouse; an output unit 1007, such as various types of displays or speakers; a storage unit 1008, such as a magnetic disk or an optical disc; and a communication unit 1009, such as a network interface card, a modem, or a wireless communication transceiver. The communication unit 1009 allows the electronic device 1000 to exchange information/data with other devices through a computer network, such as the Internet, and/or various telecommunications networks.

The computing unit 1001 may be various general-purpose and/or special-purpose processing components with processing and computing capabilities. Some examples of the computing unit 1001 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 1001 performs the foregoing methods and processes, such as the model training method or the pedestrian re-identification method. For example, in some embodiments, the model training method or the pedestrian re-identification method may be implemented as a computer software program, which is tangibly contained in a machine-readable medium, such as the storage unit 1008. In some embodiments, a part or all of the computer program may be loaded and/or installed onto the electronic device 1000 via the ROM 1002 and/or the communication unit 1009. When the computer program is loaded onto the RAM 1003 and executed by the computing unit 1001, one or more steps of the model training method or the pedestrian re-identification method described above can be performed. Alternatively, in other embodiments, the computing unit 1001 may be configured, by any other suitable means (for example, by means of firmware), to perform the model training method or the pedestrian re-identification method.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

The specific implementations above do not constitute a limitation on the protection scope of the present disclosure. Those skilled in the art should understand that various modifications, combinations, sub-combinations, and replacements can be made based on design requirements and other factors. Any modifications, equivalent replacements, improvements, etc. within the spirit and principle of the present disclosure shall fall within the protection scope of the present disclosure.

1. A model training method, comprising:
performing, by using a first encoder, feature extraction on a first pedestrian image and a second pedestrian image in a sample dataset, to obtain an image feature of the first pedestrian image and an image feature of the second pedestrian image;
fusing the image feature of the first pedestrian image and the image feature of the second pedestrian image, to obtain a fused feature;
performing, by using a first decoder, feature decoding on the fused feature, to obtain a third pedestrian image; and
determining the third pedestrian image as a negative sample image of the first pedestrian image, and using the first pedestrian image and the negative sample image to train a first preset model to convergence, to obtain a pedestrian re-identification model.

2. The method according to claim 1, further comprising:
determining a first similarity based on the first pedestrian image and the negative sample image;
determining, based on at least one pedestrian image other than the first pedestrian image in the sample image set, at least one second similarity respectively corresponding to the at least one pedestrian image; and
updating the first encoder and the first decoder based on the first similarity, the at least one second similarity, and an adversarial loss function.

3. The method according to claim 1, wherein a manner of obtaining the first encoder and the first decoder comprises:
performing, by using a second encoder, feature extraction on an i^{th} pedestrian image in the sample dataset, to obtain an image feature of the i^{th} pedestrian image, wherein i is a positive integer that is greater than or equal to 1;
performing, by using a second decoder, feature decoding on the image feature of the i^{th} pedestrian image, to obtain a generated image;
updating the second encoder and the second decoder based on a similarity between the i^{th} pedestrian image and the generated image, and a reconstruction loss function; and
determining the second encoder as the first encoder, and the second decoder as the first decoder when the second encoder and the second decoder meet a convergence condition.

4. The method according to claim 3, wherein the updating the second encoder and the second decoder based on a similarity between the i^{th} pedestrian image and the generated image, and a reconstruction loss function comprises:
computing a function value of the reconstruction loss function based on the similarity between the i^{th} pedestrian image and the generated image, and the reconstruction loss function;
determining, by using an authenticity discriminator, the authenticity of the generated image; and
updating the second encoder and the second decoder according to the function value of the reconstruction loss function and the authenticity of the generated image.

5. The method according to claim 1, wherein a manner of obtaining the first preset model comprises:
performing, by using a second preset model, feature extraction on each pedestrian image in the sample dataset, to obtain a pedestrian feature of each pedestrian image;
performing, based on the pedestrian feature, clustering on each pedestrian image in the sample dataset, to obtain at least two class clusters respectively corresponding to at least two class cluster labels, wherein each of the at least two class clusters comprises at least one pedestrian image; and
training, based on each pedestrian image in the sample dataset and a class cluster label corresponding to each pedestrian image, the second preset model to convergence, to obtain the first preset model.

6. The method according to claim 5, wherein the first pedestrian image and the second pedestrian image are from different class clusters in the at least two class clusters.

7. A pedestrian re-identification method, comprising:
separately performing, by using a pedestrian re-identification model, feature extraction on a target image and a candidate pedestrian image, to obtain a pedestrian feature of the target image and a pedestrian feature of the candidate pedestrian image, wherein the pedestrian re-identification model is obtained using the model training method according to claim 1;
determining a similarity between the target image and the candidate pedestrian image based on the pedestrian feature of the target image and the pedestrian feature of the candidate pedestrian image; and
determining the candidate pedestrian image as a related image of the target image when the similarity meets a preset condition.

8-14. (canceled)

15. An electronic device, comprising:
at least one processor; and
a memory communicatively connected to the at least one processor, wherein
the memory stores instructions executable by the at least one processor, and when executed by the at least one processor, the instructions cause the at least one processor to perform operations comprising:
performing, by using a first encoder, feature extraction on a first pedestrian image and a second pedestrian image in a sample dataset, to obtain an image feature of the first pedestrian image and an image feature of the second pedestrian image;
fusing the image feature of the first pedestrian image and the image feature of the second pedestrian image to obtain a fused feature;
performing by using a first decoder, feature decoding on the fused feature, to obtain a third pedestrian image; and
determining the third pedestrian image as a negative sample image of the first pedestrian image, and using the first pedestrian image and the negative sample image to train a first preset model to convergence, to obtain a pedestrian re-identification model.

16. A non-transitory computer-readable storage medium storing computer instructions, wherein the computer instructions, when executed by one or more processors, are used to cause a computer to perform the method according to claim 1.

17. (canceled)

18. A non-transitory computer-readable storage medium storing computer instructions, wherein the computer instructions, when executed by one or more processors, are used to cause a computer to perform the method according to claim 7.

19. An electronic device, comprising:
at least one processor; and
a memory communicatively connected to the at least one processor, wherein
the memory stores instructions executable by the at least one processor, and when executed by the at least one processor, the instructions cause the at least one processor to perform the method according to claim 7.

20. The electronic device according to claim 15, wherein the operations further comprise:
determining a first similarity based on the first pedestrian image and the negative sample image;
determining, based on at least one pedestrian image other than the first pedestrian image in the sample dataset, at least one second similarity respectively corresponding to the at least one pedestrian image; and
updating the first encoder and the first decoder based on the first similarity, the at least one second similarity, and an adversarial loss function.

21. The electronic device according to claim 15, wherein the operations further comprise:
performing, by using a second encoder, feature extraction on an i^{th} pedestrian image in the sample dataset, to obtain an image feature of the i^{th} pedestrian image, wherein i is a positive integer that is greater than or equal to 1;
performing, by using a second decoder, feature decoding on the image feature of the i^{th} pedestrian image, to obtain a generated image;
updating the second encoder and the second decoder based on a similarity between the i^{th} pedestrian image and the generated image, and a reconstruction loss function; and
determining the second encoder as the first encoder, and the second decoder as the first decoder when the second encoder and the second decoder meet a convergence condition.

22. The electronic device according to claim 21, wherein the updating the second encoder and the second decoder based on a similarity between the i^{th} pedestrian image and the generated image, and a reconstruction loss function comprises:
computing a function value of the reconstruction loss function based on the similarity between the i^{th} pedestrian image and the generated image, and the reconstruction loss function;
determining, by using an authenticity discriminator, the authenticity of the generated image; and
updating the second encoder and the second decoder according to the function value of the reconstruction loss function and the authenticity of the generated image.

23. The electronic device according to claim 15, wherein the operations further comprise:
performing, by using a second preset model, feature extraction on each pedestrian image in the sample dataset, to obtain a pedestrian feature of each pedestrian image;
performing, based on the pedestrian feature, clustering on each pedestrian image in the sample dataset, to obtain at least two class clusters respectively corresponding to at least two class cluster labels, wherein each of the at least two class clusters comprises at least one pedestrian image; and
training, based on each pedestrian image in the sample dataset and a class cluster label corresponding to each pedestrian image, the second preset model to convergence, to obtain the first preset model.

24. The electronic device according to claim 23, wherein the first pedestrian image and the second pedestrian image are from different class clusters in the at least two class clusters.
